(19) United States
(12) Patent Application Publication
(10) Pub. No.: US 2013/0217265 A1
(43) Pub. Date: Aug. 22, 2013

(54) SOCKET

(71) Applicant: ECOBILITY GMBH, (US)

(72) Inventors: Urs Schlaepfer, Zurich (CH); Guenter Schiessl, Munchen (DE)

(73) Assignee: ECOBILITY GMBH, Munchen (DE)

(21) Appl. No.: 13/770,626

(22) Filed: Feb. 19, 2013

(30) Foreign Application Priority Data
Feb. 17, 2012 (DE) 10 2012 003 197.1

(51) Int. Cl. H01R 33/00

(52) U.S. Cl. CPC H01R 33/00
USPC 439/639; 439/217; 439/131

(57) ABSTRACT

A socket with a socket body which has at least one upwardly-directed side is described. The socket includes a mains-voltage jack arranged in the socket body and one or more low-voltage plugs. The low-voltage plug(s) is/are arranged or is/are capable of being arranged on the upwardly-directed side of the socket body, standing upright.

### TECHNICAL FIELD

The present invention relates generally to a socket. More precisely, a socket is proposed that provides both mains voltage (i.e., line voltage) and low voltage.

### BACKGROUND

The number of mobile devices has risen rapidly in recent years, and there is no sign of this increase coming to an end. Mobile phones, smart phones, digital cameras, portable music players (e.g. MP3 players), tablet computers and portable navigation devices may be mentioned in exemplary manner in this context.

The mobility of these devices is guaranteed by batteries. Rechargeable batteries often come into operation here. Rechargeable batteries of such a type have to be charged from time to time via a power supply unit—normally supplied together with the device—at a socket. Problematic in this connection is the fact that the power supply unit is not always carried by the user. In the case of trips to foreign countries, an aggravating factor is that, due to the differing socket standards from country to country, not every power supply unit fits into every socket.

These disadvantages are partly solved by the fact that many mobile devices can in the meantime be attached to a computer via a charging cable and can be charged via the power supply of said computer. The mobile device is typically connected to the computer via a USB port.

On trips, however, in many cases—for instance, in the evening in a hotel—neither a suitable power supply unit nor a suitable computer is available in order to be able to recharge a mobile device at the end of a working day. For this reason, sockets that do not only have a mains-voltage jack (i.e., line voltage jack) but also a low-voltage jack with an associated voltage transformer have meanwhile come into operation in good hotels. Such a socket is known from DE 10 2010 000 442 A1. In this socket the low-voltage jack has the form of an USB port to which—via a suitable charging cable—the mobile device can be attached for the purpose of charging.

If also no charging cable is available, the socket known from DE 20 2009 013 645 U1provides a remedy. Integrated into this socket is a charging cable with, for example, a USB plug. Furthermore, the socket has a placement surface, in order to be able to set the mobile device down during the charging process. The integration of a charging cable into the socket and the handling thereof are, however, elaborate, particularly as far as the stowage of the charging cable before and after the charging process is concerned. For this reason, the solution known from DE 20 2009 013 645 U1 is not really suitable for hotels and similar much-frequented areas.

A socket having a low-voltage jack is also known from DE 10 2010 036 338 A1. In the case of this socket, having the form of a socket strip, the low-voltage jack has the form of a rotatable USB jack to which the mobile device can be attached for the purpose of charging via a suitable charging cable. Furthermore, U.S. Pat. No. 6,780,048 B2discloses a socket strip onto which a USB plug can be releasable plugged.

### SUMMARY

The object underlying the invention is to provide a socket having a mains-voltage supply connection and a low-voltage supply connection, which can be handled safely and easily in connection with the use of the low-voltage supply connection.

Accordingly, a socket is provided that has a socket body, at least one mains-voltage jack arranged in the socket body, and at least one low-voltage plug which is rotatably attached to the socket body by a bearing.

According to another variant, a socket is provided that has a socket body, at least one mains-voltage jack arranged in the socket body, and at least one low-voltage plug which is attached to the socket body so as to be lowerable (e.g., retractable) in a plane perpendicular to the plug-in axis of the mains-voltage jack, or slidable (e.g., displaceable) parallel thereto.

According to a further variant, a socket is provided that has a socket body, at least one mains-voltage jack arranged in the socket body, and two low-voltage plugs which are fastened to the socket body in series with respect to a plug-in axis of the mains-voltage jack.

According to a further variant, a socket is provided that has a socket body with at least one upwardly-directed side, at least one mains-voltage jack arranged in the socket body, and at least one low-voltage plug arranged or capable of being arranged on the upwardly-directed side of the socket body, standing substantially upright. The upright position may extend substantially perpendicular to a plug-in axis of the mains-voltage jack.

Alternatively, the upright position may extend substantially parallel or in another arbitrary direction (e.g., transverse/oblique or with a specific angle) to a plug-in axis of the mains-voltage jack.

The upwardly-directed side may have been designed to be planar or non-planar. According to one variant, the upwardly-directed side is formed by an upper side of a housing of the socket body. According to another variant, the upwardly-directed side is formed at an arbitrary position below this upper side. The upwardly-directed side may be a side upwardly-directed in the mounted state of the socket. According to a variant, the upwardly-directed side may extend substantially parallel to a plug-in axis of the mains-voltage jack. In this case, the plug-in axis of the mains-voltage jack may be in a plane of the upwardly-directed side.

The at least one low-voltage plug may be designed to be rigid (or fix) with respect to the socket body, or alternatively may be designed to be movable. The movability may be guaranteed in different ways. For example, the low-voltage plug may be movable in such a manner that it can be moved partly or completely beneath a plane defined by an upper side of the housing. If the low-voltage plug is moved completely beneath this plane, then in any case no contact region of the low-voltage plug protrudes beyond this plane.

According to a variant, two movable low-voltage plugs are provided adjacent to one another in such a manner that one of the two low-voltage plugs has to be moved in order to be able to plug a mobile device onto the other low-voltage plug.

The at least one low-voltage plug may be partly or completely movable inwards into the socket body. In such a case the socket body may have a recess, in order to receive the at least one low-voltage plug. The recess may be closable by means of a suitable cover.

The movability of the low-voltage plug may involve a rotatability (e.g. a tilting capacity or a swivelling capacity). Accordingly, the low-voltage plug may be designed to be rotatable, in order to be brought into a substantially horizontal position. In this case the socket body may have a recess formed laterally relative to the low-voltage plug, in order to receive the low-voltage plug partly or completely in the horizontal position.

Furthermore, a stop may be provided, in order to limit a rotary movement of the at least one low-voltage plug into the upright position. In this case a damper (e.g. a damping element or a damping mechanism) may additionally be provided functionally between the stop and the low-voltage plug. The damper may consist, for example, of an elastic material such as rubber or foamed plastic and, according to a variant, may constitute the stop or may be attached on the stop. Possible damping mechanisms may be a spring element (for example, a helical spring) and may be attached in the region of an axis of rotation of the low-voltage plug or elsewhere.

According to a further option, the low-voltage plug may be designed to be translationally movable. Accordingly, the low-voltage plug may have a longitudinal axis and may be translationally movable parallel to this longitudinal axis. As an alternative, the low-voltage plug may be designed to be translationally movable (e.g. slidable) perpendicular to its longitudinal axis.

A supply mechanism may be provided, in order to make the low-voltage plug accessible for a mobile device. The supply mechanism may be designed—for example, in the case of a low-voltage plug designed to be translationally movable—in the manner of the spring-force-based ejection mechanism for SD cards or in the manner of the ejection mechanism of CD-ROM readers. In the case of a rotatable low-voltage plug, the supply mechanism may be realised in the manner of an opening mechanism, subjected to spring force, for a cassette compartment of a cassette player. In the simplest case the supply mechanism enables a manual movement of the low-voltage plug, whereby its upright position in such a case can be secured by means of a detent mechanism.

According to one embodiment, two or more low-voltage plugs may be arranged on the upwardly-directed side. The several low-voltage plugs may be arranged in series or next to each other (with respect to a plug-in axis of the mains-voltage jack). Accordingly, the several low-voltage plugs may be arranged next to each other substantially in a plane perpendicular to this plug-in axis. A single (i.e., only one) low-voltage plug may be arranged or capable of being arranged substantially in a plane perpendicular to this plug-in axis.

The upwardly-directed side or another element may provide a supporting region for a mobile device that has been plugged onto the at least one low-voltage plug. The supporting region may be designed to be planar or non-planar (that is to say, for example, punctiform or linear). Furthermore, the supporting region may be realised movably (for example, capable of being folded away).

The at least one low-voltage plug may be selected from one or more of the following plug types: regular USB plug, Apple® dock connector plug, mini USB plug, micro USB plug, charging plug for a mobile phone, charging plug for a tablet computer, charging plug for a smart phone and charging plug for a digital camera.

According to a variant, the socket further includes a flush-mounted part for wall mounting. The flush-mounted part may be integrated into the socket body or alternatively may be provided separately from the socket body.

Two or more mains-voltage jacks with different plug schemes may be arranged in the socket body. The two or more mains-voltage jacks may be arranged spatially next to each other and/or in the manner of a multi-jack in the same spatial region.

The mains-voltage jack may be a Schuko-jack (e.g., a jack according to the European or German specifications and having an earthing contact). If a flush-mounted part is provided, the Schuko-jack may be provided concentrically relative to the flush-mounted part.

### BRIEF DESCRIPTION OF THE DRAWINGS

Further aspects, features and advantages of the socket disclosed herein will become apparent from the following discussed embodiments and from the Figures. Shown are:

FIG. 1 a perspective view of a first embodiment of a socket;

FIG. 2 a front view of the socket according to FIG. 1;

FIG. 3 a side view of the socket according to FIG. 1;

FIG. 4 a top view of the socket according to FIG. 1;

FIG. 5 a perspective partial view of the upper side of the socket according to FIG. 1;

FIG. 6 a perspective exploded view of the socket according to FIG. 1;

FIG. 7 a lateral exploded view of the socket according to FIG. 1;

FIG. 8 a front view of the socket according to FIG. 1 with mobile device plugged in (indicated schematically);

FIG. 9 a perspective view of a further embodiment of a socket;

FIG. 10 a front view of the socket according to FIG. 9; and

FIG. 11 a top view of the socket according to FIG. 9.

### DETAILED DESCRIPTION

In the following, several embodiments of a socket will be explained in exemplary manner. Corresponding or comparable elements are provided with the same reference numerals.

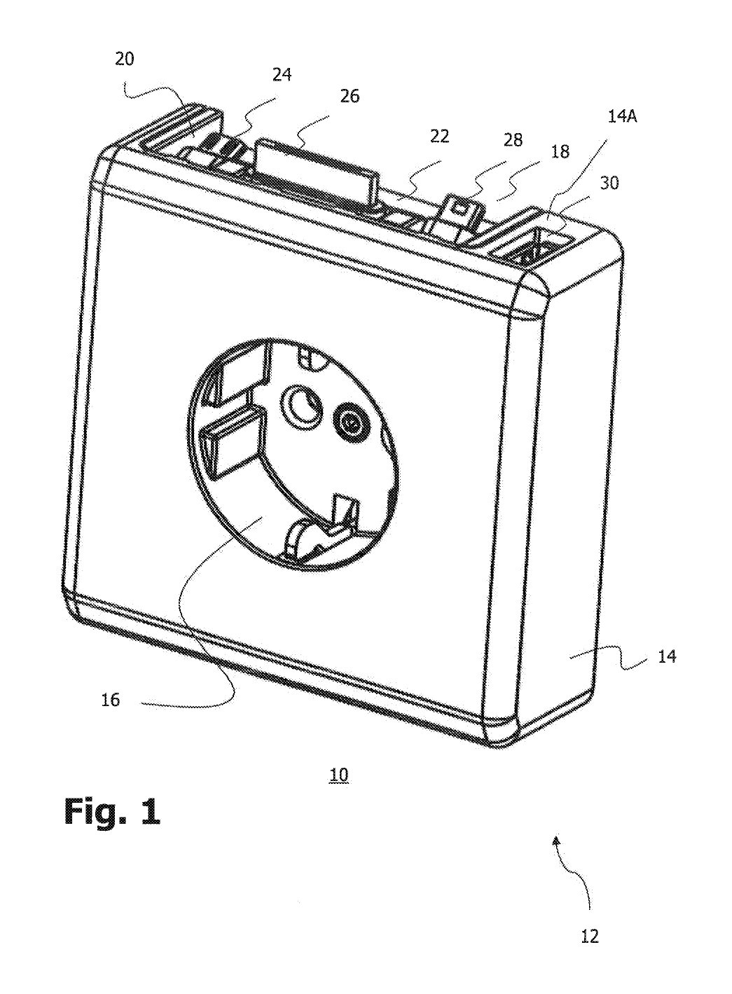

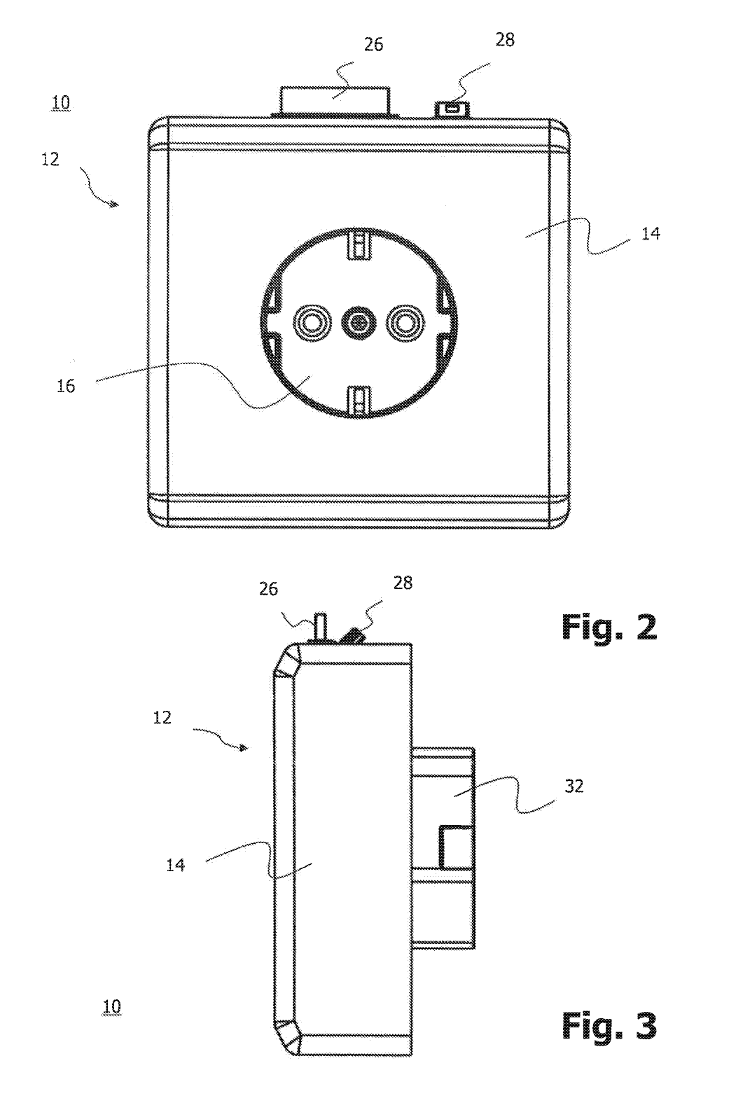

In FIGS. 1 to 8 a first embodiment of a socket 10 is shown. This socket 10 will firstly be explained with reference to FIGS. 1 to 4.

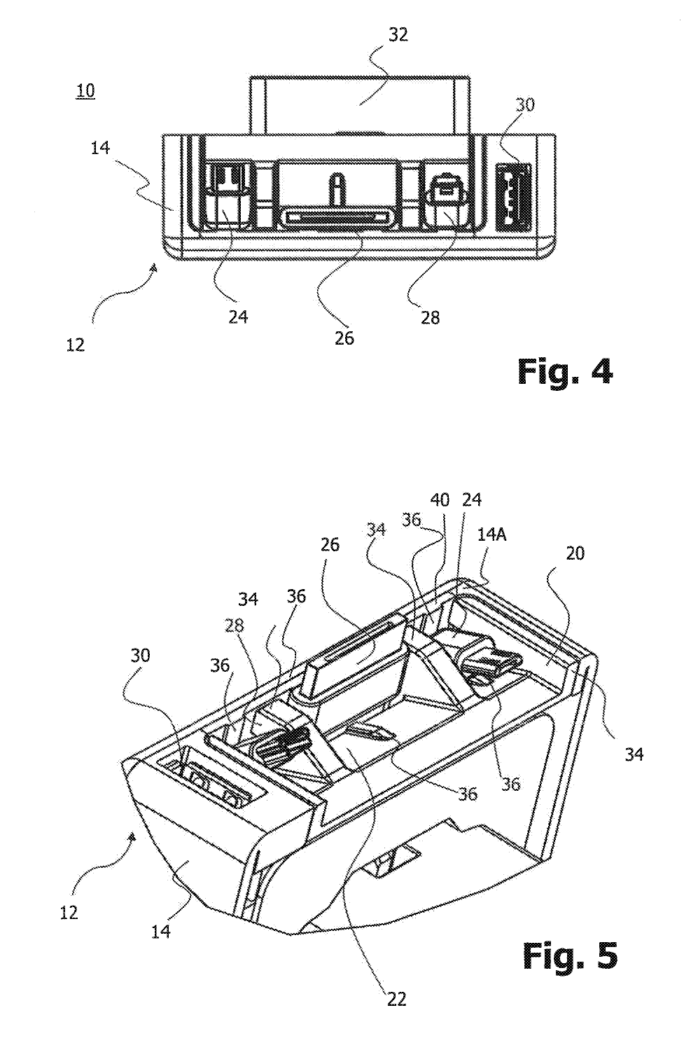

The socket 10 includes a socket body 12 with a housing 14. The housing 14 is formed as a cuboid with a substantially square base. The socket body 12 further includes a mains-voltage jack 16 arranged therein. In the present embodiment, the mains-voltage jack 16 is a conventional Schuko-jack according to DIN 49440/441. On its upper side 14A the housing 14 has an opening 18 which permits access to a recess 20 in the socket body 12. This recess 20 has a side 22 upwardly-directed in the mounted state of the socket 10. On this upwardly-directed side 22 a total of three low-voltage plugs 24, 26, 28 are provided. The first low-voltage plug 24 is a micro USB plug, the second low-voltage plug 26 is an Apple® dock connector plug, and the third low-voltage plug 28 is a mini USB plug. As can best be seen in FIG. 4, the low-voltage plugs 24, 26, 28 are arranged next to each other. More precisely, the low-voltage plugs 24, 26, 28 extend next to each other within a plane perpendicular to the plug-in axis of the mains-voltage jack 16. Further, on the upper side 14A of the housing 14 a low-voltage jack 30 is provided. The low-voltage jack 30 conforms likewise to the USB standard.

Whereas via the mains-voltage jack 16 (in Germany) alternating (a.c.) voltage of, typically, 220-230 V is provided, the low-voltage plugs 24, 26, 28 and the low-voltage jack 30 serve for supplying a mobile device (not shown in FIGS. 1 to 4) with direct (d.c.) voltage. The d.c. voltage is typically used for charging and/or operating the mobile device.

As shown in FIGS. 3 and 4, the socket body 12 includes, in addition to the housing 14, a flush-mounted part 32 for wall mounting. Whereas the housing 14 forms a surface-mounted part, in the mounted state of the socket 10 the flush-mounted part 32 is completely received in a wall.

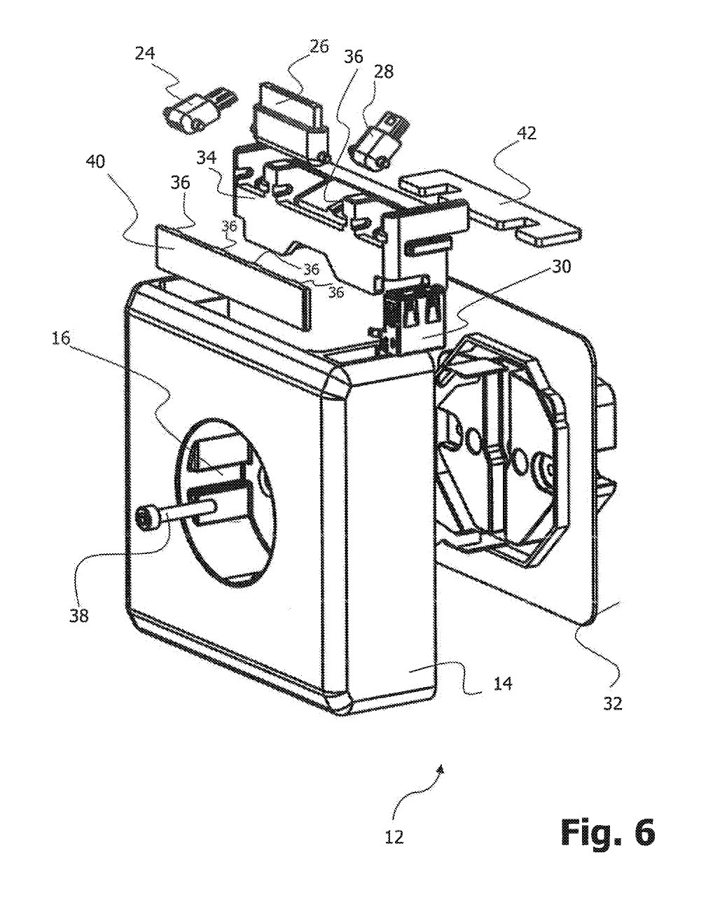

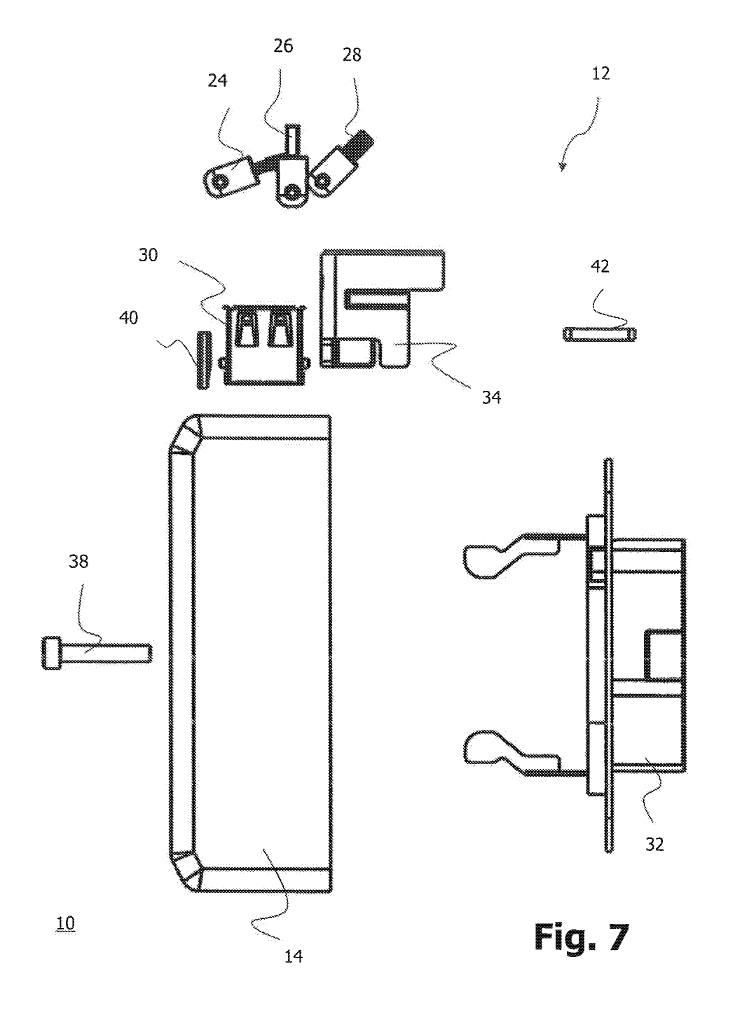

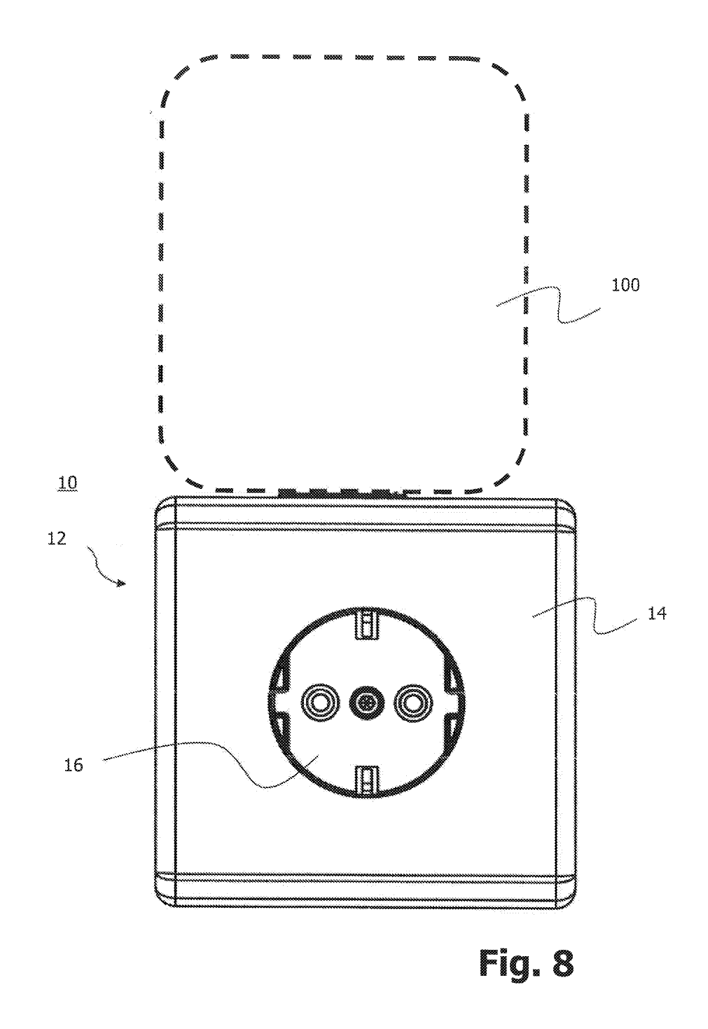

In the following the functionality of the low-voltage plugs 24, 26, 28 will be explained in more detail with reference to the perspective enlarged detail according to FIG. 5, the two exploded views according to FIGS. 6 and 7, as well as the schematic drawing according to FIG. 8.

As shown in FIG. 5, the low-voltage plugs 24, 26, 28 are arranged in the recess 20 of the socket body 12. The recess 20 is limited by a housing insert 34 provided on the upper side 14A of the housing 14. In a direction perpendicular to a plug-in axis of the mains-voltage jack 16 the housing insert 34 has a substantially U-shaped cross section. In the present embodiment, the bottom of the U defines the upwardly-directed side 22 of the socket body 12. It will be understood that in other embodiments this upwardly-directed side 22 may also be formed at other positions of the socket body 12.

The low-voltage plugs 24, 26, 28 are movably arranged in the socket body 12. In the present embodiment, the low-voltage plugs 24, 26, 28 are rotatably supported in the region of the upwardly-directed side 22, in order to be moved optionally into a horizontal position or an upright position. In the embodiment, the upright position extends substantially perpendicular to the plug-in axis of the mains-voltage jack 16, whereas the horizontal position extends substantially parallel thereto. It will be understood that certain angular deviations with respect to the perpendicular or the parallel are entirely permissible and do not impair the concept presented herein.

In the exemplary FIGS. 1 to 7 the first low-voltage plug 24 is located in exemplary manner in a horizontal position, whereas the second low-voltage plug 26 is located in an upright position and the third low-voltage plug 28 occupies an intermediate position between the horizontal position and the upright position. In the upright position of one of the low-voltage plugs 24, 26, 28 the actual contact region extends, in any case, so far beyond a plane defined by the upper side 14A of the housing 14 that a mobile device 100 can be plugged onto this low-voltage plug 24, 26, 28 in contacting manner (cf. FIG. 8). A supporting region for the plugged-in mobile device 100 may in this case be provided by a contact housing of the low-voltage plug 24, 26, 28, by the upper side 14A of the housing 14, or alternatively by suitable supporting structures in the housing insert 34, such as, for example, by the ribs 34 illustrated in FIG. 5.

In the horizontal position shown in FIG. 5, the low-voltage plug 24 is arranged completely below a plane defined by the upper side 14A of the housing 14. In such a horizontal position the low-voltage plugs 24, 26, 28 are consequently received in protected manner within the recess 20. In addition, the horizontal arrangement—for example of the two low-voltage plugs 24, 28 in the case of an upright position of low-voltage plug 26—also permits a wider mobile device 100, such as a tablet computer, to be plugged on the low-voltage plug 26 (cf. FIG. 8). The movability of the low-voltage plugs 24, 26, 28 therefore enables a more compact form of construction of the socket body 12, particularly in applications in which several low-voltage plugs are arranged closely next to each other.

In the present embodiment the low-voltage plugs 24, 26, 28 can be transferred manually (i.e. by means of one or more fingers) from the horizontal position into the upright position (and back again). Both positions are defined by suitable stops 36 and optional detent structures (not shown). In each of the Figures only some of the stops 36 are visible. The individual stops 36 may be formed from or covered by an elastic material such as rubber or foamed plastic. Particularly for those stops 36 which limit the upright position of the low-voltage plugs 24, 26, 28, dampers of such a type are useful, in order to prevent the low-voltage plugs 24, 26, 28 from being levered out of their bearing in the insert 34 in the case of an angled removal of a mobile device 100 plugged thereon, or at least to counteract such a leverage.

The bearing of the low-voltage plugs 24, 26, 28 in the socket body 12 can best be seen from the two exploded views shown in FIGS. 6 and 7. As shown in these exploded views, the underside contact housing of each of the three low-voltage plugs 24, 26, 28 is provided on opposite sides with bearing pins which engage rotatably in corresponding bearing grooves in the insert 34. In this case, the axes of rotation of the low-voltage plugs 24, 26, 28 are arranged coaxially relative to one another and extend in a plane perpendicular to the plug-in axis of the mains-voltage jack 16. The course of this plug-in axis is illustrated in FIGS. 6 and 7 by a fastening screw 38 with which the housing 14 is fastened to the flush-mounted part 32.

After the insertion of the bearing pins provided on the contact housings of the low-voltage plugs 24, 26, 28 into the bearing grooves formed in the insert 34, the bearing grooves are closed by means of a wall part 40. As shown in FIG. 6, the stops 36 provided for the upright position are formed on this wall part.

A printed circuit board (PCB) 42 which has been sketched merely schematically is inserted in the housing insert 34. The electronic components for transforming the a.c. voltage obtained from the mains into a d.c. voltage according to the respective specification of the low-voltage plugs 24, 26, 28 are arranged on the printed circuit board 42. Not shown in FIGS. 1 to 7 is the cable connection between the low-voltage plugs 24, 26, 28 and the printed circuit board 42 or between the printed circuit board 42 and mains-voltage contacts in the region of the flush-mounted part 32.

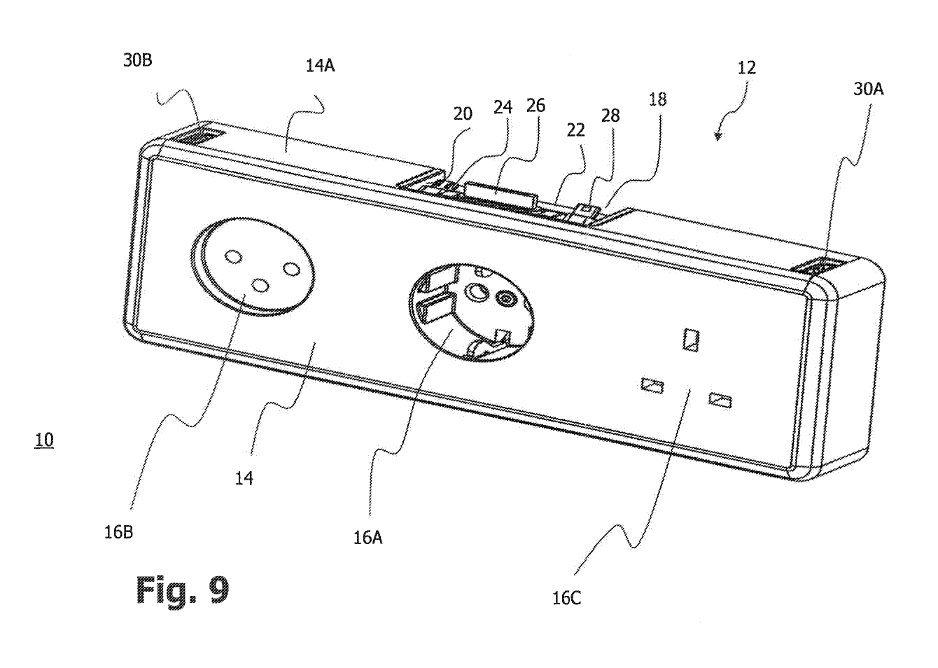

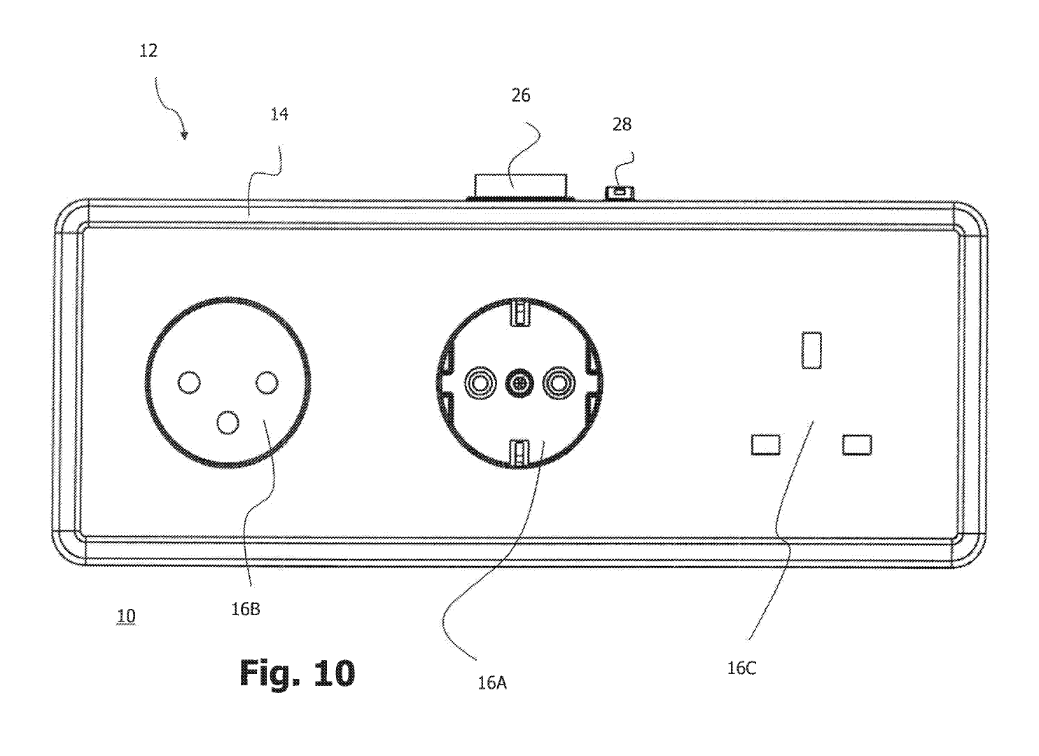

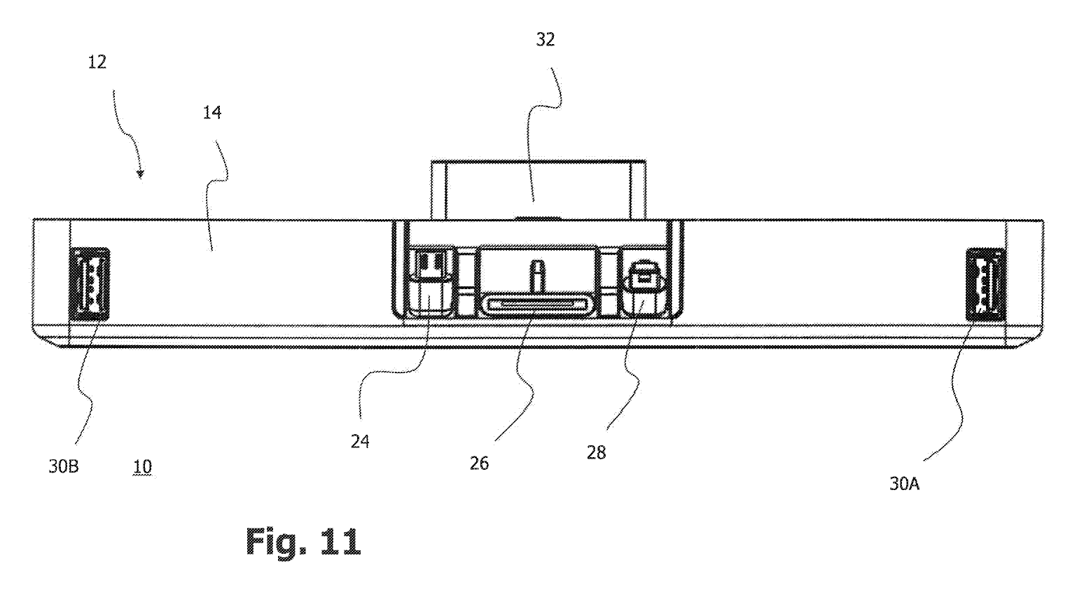

In FIGS. 9 to 11 a further embodiment of a socket 10 is shown. With regard to the low-voltage plugs 24, 26, 28, the embodiment according to FIGS. 9 to 11 corresponds to the embodiment described above.

Departing from the embodiment described above, a total of three mains-voltage jacks 16A, 16B, 16C arranged spatially next to each other are provided, wherein the middle mains-voltage jack 16A is again formed as a Schuko-jack, and the lateral jacks 16B and 16C correspond to plug schemes according to the Swiss and British specifications, respectively. The arrangement of several mains-voltage jacks 16A, 16B, 16C next to each other leads to an enlarged form of construction of the housing 14, but therefore also to a larger supporting surface for mobile devices 100 on the upper side 14A of the housing 14. Furthermore, the larger form of construction enables the provision of two low-voltage jacks 30A, 30B.

Departing from the two embodiments described above, mains-voltage jacks having different plug schemes may be arranged in the same spatial region in the manner of a multi-jack. Furthermore, in a manner departing from the embodiments described herein, it would be conceivable to form the low-voltage plugs to be translationally movable. Accordingly, the low-voltage plugs could, for example, be formed to be translationally lowerable (e.g., retractable) in a plane perpendicular to the plug-in axis of the mains-voltage jack, or alternatively to be slidable (e.g., displaceable) is parallel thereto.

1. Socket, with
a socket body;
at least one mains-voltage jack which is arranged in the socket body; and
at least one low-voltage plug which is rotatably attached to the socket body by a bearing.

2. Socket, with
a socket body;
at least one mains-voltage jack which is arranged in the socket body; and
at least one low-voltage plug which is attached to the socket body so as to be lowerable in a plane perpendicular to the plug-in axis of the mains-voltage jack.

3. Socket, with
a socket body;
at least one mains-voltage jack which is arranged in the socket body; and
two low-voltage plugs which are fastened to the socket body in series with respect to a plug-in axis of the mains-voltage jack.

4. Socket, with
a socket body which has at least one upwardly-directed side;
at least one mains-voltage jack which is arranged in the socket body; and
at least one low-voltage plug which is arranged or is capable of being arranged on the upwardly-directed side of the socket body in a substantially upright position.

5. Socket according to claim 1,
wherein the at least one low-voltage plug is partly or completely movable inwards into the socket body.

6. Socket according to claim 5, wherein the socket body has a recess, in order to receive the at least one low-voltage plug.

7. Socket according to claim 6,
wherein the at least one low-voltage plug is designed to be rotatable, in order to be brought in the recess into a substantially horizontal position.

8. Socket according to claim 1,
wherein a stop is provided, in order to limit the rotary movement of the at least one low-voltage plug.

9. Socket according to claim 8,
wherein a damper is provided functionally between the stop and the at least one low-voltage plug.

10. Socket according to claim 2,
wherein the at least one low-voltage plug has a longitudinal axis and is translationally movable parallel to this longitudinal axis.

11. Socket according to claim 1,
wherein two or more low-voltage plugs are arranged on one side of the socket body.

12. Socket according to claim 11,
wherein the two or more low-voltage plugs are arranged next to each other.

13. Socket according to claim 11,
wherein two movable low-voltage plugs are arranged in a plane, so that one of the two low-voltage plugs has to be moved in order to be able to plug a mobile device onto the other low-voltage plug.

14. Socket according to claim 11,
wherein the two or more low-voltage plugs are arranged substantially in a plane perpendicular to a plug-in axis of the mains-voltage jack.

15. Socket according to claim 1,
wherein a supporting region for a mobile device plugged onto the at least one low-voltage plug is formed.

16. Socket according to claim 1,
wherein the at least one low-voltage plug is selected from one or more of the following plug types: regular USB plug, Apple® dock connector plug, mini USB plug, micro USB plug, charging plug for a mobile phone, charging plug for a tablet computer, charging plug for a smart phone, charging plug for a digital camera.

17. Socket according to claim 1,
which has a flush-mounted part for wall mounting.

18. Socket according to claim 1,
wherein two or more mains-voltage jacks having different plug schemes are arranged in the socket body.

19. Socket according to claim 18,
wherein the two or more mains-voltage jacks are arranged spatially next to each other and/or in the manner of a multi-jack in the same spatial region.

20. Socket according to claim 1,
wherein the socket body has a housing having the form of a surface-mounted part.
